(19) United States
(12) Patent Application Publication
(10) Pub. No.: US 2008/0239257 A1
(43) Pub. Date: Oct. 2, 2008

(54) Stage Apparatus and Exposure Apparatus

(76) Inventors: Shigeru Hagiwara, Saitama-ken (JP); Naohiko Iwata, Saitama-ken (JP); Masaya Iwasaki, Saitama-ken (JP); Tadashi Hoshino, Saitama-ken (JP); Chizuko Motoyama, Chiba-ken (JP); Yuzo Kato, Tokyo (JP)

Correspondence Address: STAAS & HALSEY LLP, SUITE 700, 1201 NEW YORK AVENUE, N.W., WASHINGTON, DC, 20005, US

(21) Appl. No.: 11/575,044

(22) PCT Filed: Sep. 8, 2005
(86) PCT No.: PCT/JP05/16552

§ 371 Date: Nov. 27, 2007

(30) Foreign Application Priority Data
Sep. 10, 2004 (JP) 2004-263882

(51) Int. Cl. G03B 27/52

(52) U.S. Cl. 355/30

(57) ABSTRACT

A stage apparatus which can highly accurately measure the position of a stage, while achieving a high throughput, and an exposure apparatus provided with the stage apparatus. A stage apparatus is provided with: air-conditioning apparatuses (28X, 28Y) that supply temperature controlled air (down flow), which comes from a +Z direction to a −Z direction, to a light path of a laser beam radiated from a laser interferometer onto moving mirrors (26X, 26Y) provided on a wafer stage (WST); and an air conditioning apparatus (29) that supplies temperature controlled air (lower layer side flow), which comes from a −Y direction to a +Y direction, to a space lower than the light path of the laser beam. Furthermore, an air conditioning apparatus (34), which supplied temperature controlled air to a light path of an autofocusing sensor composed of an irradiation optical system (33a) and a light receiving optical system (33b), is provided.

### TECHNICAL FIELD

The present invention relates to a stage apparatus provided with a stage configured to be movable and an exposure apparatus provided with the stage apparatus.

This application claims priority to Japanese Patent Application No. 2004-263882, filed on Sep. 10, 2004, the contents of which are incorporated herein by reference.

### BACKGROUND ART

In manufacturing semiconductor devices, liquid crystal display devices, image pickup devices, thin-film magnetic heads, and other microdevices, exposure apparatuses for transferring a pattern formed on a mask or reticle (hereinafter, which may be generically referred to as “mask”) onto a wafer, a glass plate, or the like (hereinafter, which may be generically referred to as “substrate”) are used. In general, since a device is formed by overlapping a plurality of layers of patterns on the substrate, it is necessary to superimpose an image of a mask pattern, to be projected onto the substrate through a projection optical system PL, on a pattern already formed on the substrate with a high degree of precision.

For this reason, a laser interferometer for detecting the position of each of stages is provided on a mask stage for holding the mask and a substrate stage for holding the substrate, respectively. The laser interferometer radiates high-coherent measurement light such as laser light to a moving mirror provided on the substrate stage or mask stage and high-coherent reference light to a fixed mirror the position of which is fixed to detect interference light obtained by causing interference between the measurement light reflected by the moving mirror and the reference light reflected by fixed mirror in order to detect the position of the substrate stage or the mask stage. The laser interferometer has a high resolution of, for example, about 0.1 to 1 nm.

When a variation in ambient temperature or air fluctuation occurs, the detection accuracy of the laser interferometer is degraded due to a change in the light path length of the measurement light or the light path length of the reference light. To prevent the degradation of detection accuracy and maintain high detection accuracy, air conditioning apparatuses are used to maintain a uniform temperature and a uniform flow rate throughout the light paths of the measurement light and the reference light, respectively. For example, the following patent document 1 discloses an air conditioner for supplying temperature-controlled gas from a direction above the light path of the measurement light toward a direction below the light path.

Further, in order to match the substrate surface to the image plane of the projection optical system, the exposure apparatus includes an autofocus sensor (AF sensor) for detecting the vertical position of the upper surface of the substrate stage for holding the substrate and the inclination of the upper surface of the substrate stage (attitude of the substrate stage). This AF sensor is a sensor that also radiates a detection beam at least at one point on the substrate stage from an oblique direction with respect to the upper surface of the substrate stage to detect the reflected light in order to detect the vertical position and inclination of the substrate stage. Therefore, when a variation in ambient temperature or air fluctuation occurs, the detection accuracy of the AF sensor is also degraded.

The following patent document 2 discloses an air conditioner for supplying temperature-controlled air to the light path of measurement light and over the substrate stage (to the light path of the detection beam from the AF sensor) from oblique directions with respect to each of the light paths of the measurement light set along two directions (X direction and Y direction) orthogonal to each other (i.e., from a direction 45 degrees to the X direction and the Y direction), respectively. Further, the following patent document 3 discloses an air conditioner for supplying temperature-controlled gas from a direction (e.g., from the X direction) across the entire space including the light path of the measurement light set along two directions (X direction and the Y direction) orthogonal to each other and the substrate stage.

Patent Document 1: Japanese Patent Application, Publication No. H01-18002

Patent Document 2: Japanese Patent Application, Publication No. H09-22121

Patent Document 3: Japanese Patent Application, Publication No. H09-82626

### DISCLOSURE OF INVENTION

### Problems to be Solved by the Invention

Recently, it has been required to improve throughput (the number of substrates capable of being subjected to exposure per unit time), and in response to this requirement, the maximum velocity of the stage has been pushed up. Further, as the patterns to be transferred to a substrate become finer, more accurate alignment than the conventional is required, resulting in the need to further increase the detection accuracy of the laser interferometer and the AF sensor.

However, as the maximum velocity of the stage is pushed up, the amount of heat generated from a drive motor for driving the stage also increases to cause air fluctuation in the light path of the measurement light or the like, resulting in a reduction in detection accuracy of the laser interferometer. Further, as the maximum velocity of the stage is pushed up, the amount of agitation of air around the stage also increases due to the movement of the stage to increase the amount of air to get mixed in the light path of the measurement light or the like. Since this air is different in temperature from the air supplied from the air conditioning apparatus, air fluctuation occurs in the light path of the measurement light or the like, resulting in a reduction in the detection accuracy of the laser interferometer.

The air conditioner disclosed in the aforementioned patent document 1 works well to eliminate the influence of heat sources provided around the stage to cause air fluctuation in the light path of the measurement light or the like. However, when the air fluctuation occurs in the light path of the measurement light or the like due to the above-mentioned factor, since the required detection accuracy has been increased, the required detection accuracy cannot be achieved even if the amount of air supply increases. The same thing can be said about the AF sensor.

The present invention has been made in view of the aforementioned circumstances, and it is an object thereof to provide a stage apparatus capable of measuring the position of a stage with a high degree of precision while achieving high throughput, and an exposure apparatus provided with the step apparatus.

### Means for Solving the Problem

The present invention employs the following structure associated with each drawing showing a preferred embodiment. It should be noted here that reference numerals within parentheses given to corresponding elements are just illustrative examples of the elements and are not intended to limit each element.

To solve the above-mentioned problems, a stage apparatus according to a first aspect of the present invention is a stage apparatus including a stage (25, WST) configured to be movable within a moving range on a reference plane (BP), and an interferometer (27, 27X, 27Y) that irradiates the stage with a light beam parallel to the reference plane to measure the position of the stage, the apparatus comprising: a first air-conditioning mechanism (28X, 29Y) that supplies a gas adjusted to a predetermined temperature toward the light path of the light beam along a direction orthogonal to the reference plane; and a second air-conditioning mechanism (29) that supplies a gas adjusted to a predetermined temperature into a space between the light path of the light beam and the reference plane along the given plane.

According to this invention, the gas adjusted to the predetermined temperature is supplied from a first air conditioning apparatus toward the light path of the light beam radiated from the interferometer along the direction orthogonal to the reference plane, and the gas adjusted to the predetermined temperature is supplied from a second air conditioning apparatus into the space between the light path of the light beam and the reference plane along the given plane.

To solve the above-mentioned problems, a stage apparatus according to a second aspect of the present invention is a stage apparatus including a stage (25, WST) configured to be movable within a moving range on a reference plane (BP), an interferometer (27, 27X, 27Y) that irradiates the stage with a light beam parallel to the reference plane to measure the position of the stage, and a drive device (38a, 38b) arranged outside of the moving range to drive the stage based on the measurement results from the interferometer, the apparatus comprising: a shield member (39a, 39b, 42a, 42b, 43a, 43b, 45a to 49a, 45b to 48b) that shields a space where the drive device is arranged from a space where at least the stage is arranged.

According to this invention, the space where the drive device is a arranged is shielded by the shield member from the space where the stage is arranged.

To solve the above-mentioned problems, a stage apparatus according to a third aspect of the present invention is a stage apparatus including a stage (25, WST) having a holding surface that holds a substrate (W) and moving over a reference plane, the apparatus comprising: a supply mechanism (34) that supplies a gas adjusted to a predetermined temperature into a space over the holding surface; and an air-intake mechanism (35) provided to face the supply mechanism to suck in the gas over the holding surface.

According to this invention, the gas adjusted to the predetermined temperature and supplied from the supply mechanism over the holding surface of the stage is sucked in by the air-intake mechanism.

An exposure apparatus of the present invention is an exposure apparatus (EX) including a mask stage (RST) that holds a mask (R) and a substrate stage (WST) that holds a substrate (W) to transfer a pattern formed on the mask onto the substrate, the apparatus comprising the stage apparatus according to any one of the aspects of the present invention as at least either the mask stage or the substrate stage.

To solve the above-mentioned problems, an exposure apparatus according to a second aspect of the present invention is an exposure apparatus (EX) that radiates exposure light to form a pattern on a substrate (W), the apparatus comprising: a stage (WST) movable over a reference plane (BP) formed on a stage base (23) while holding the substrate; a first interferometer (27Y) that irradiates the stage with a light beam parallel to the reference plane along a first direction (Y axis direction) to measure the position of the stage in the first direction; a second interferometer (27X) that irradiates the stage with a laser beam parallel to the reference plane along a second direction (X axis direction) orthogonal to the first direction to measure the position of the stage in the second direction; a first air-conditioning mechanism (28Y, 28X) that supplies a gas adjusted to a predetermined temperature toward the light path of each light beam along a direction orthogonal to the reference plane; and a second air-conditioning mechanism (29) that supplies a gas adjusted to a predetermined temperature into a space between the light path of the light beam and the reference plane in a direction parallel to the first direction along the reference plane.

### EFFECTS OF THE INVENTION

According to the present invention, the gas adjusted to the predetermined temperature is supplied toward the light path of the light beam radiated from the interferometer in the direction orthogonal to the reference plane, and the gas adjusted to the predetermined temperature is supplied from the second air conditioning apparatus into the space between the light path of the light beam and the reference plane along the given plane. Therefore, the air stagnant in the space between the light path of the light beam and the reference plane can be eliminated, and even if a pressure difference occurs between both ends of the stage in the moving direction during stage movement at high speed, temperature-uncontrolled air getting mixed in the light path of the laser light can be prevented or reduced, thereby preventing the lowering of the detection accuracy of the interferometer. As a result, the position of the stage can be measured with a high degree of precision.

Further, according to the present invention, since the shield member shields between the space where the drive device is arranged and the space where the stage is arranged, air warmed by heat generated from the drive device is prevented from getting mixed in the space where the stage is arranged even if the maximum velocity of the stage is set high and hence the amount of heat increases. This makes it possible to measure the position of the stage with a high degree of precision.

Further, according to the present invention, since the air-intake mechanism sucks in the gas adjusted to the predetermined temperature and supplied from the supply mechanism over the holding surface of the stage, temperature-uncontrolled air rolled up from the stage during movement of the stage can be evacuated promptly. This can prevent the degradation of detection accuracy of a sensor provided, for example, above the stage for detecting the attitude of the stage (inclination of the holding surface).

Further, according to the present invention, since the position and attitude of the mask and the substrate can be detected with a high degree of precision, exposure accuracy (pattern registration accuracy, etc.) can be improved. As a result, a device having a desired function can be manufactured efficiently with high yield.

### BRIEF DESCRIPTION OF THE DRAWINGS

FIG. 1 is a side view schematically showing the general structure of an exposure apparatus according to one preferred embodiment of the present invention.

FIG. 2 is a perspective view showing the schematic structure of a wafer stage.

FIG. 3A is a view for explaining the degradation of detection accuracy of a laser interferometer due to an increase in the speed of the wafer stage.

FIG. 3B is view for explaining the degradation of detection accuracy of the laser interferometer due to the increase in the speed of the wafer stage.

FIG. 4A is a view for explaining the effects of use of a down flow and a lower side flow in combination.

FIG. 4B is a view for explaining the effects of use of the down flow and the lower side flow in combination.

FIG. 5 is a view for explaining conditioned air supplied from an air conditioning apparatus over the wafer stage.

FIG. 6A is a view showing an example of the arrangement of an air-intake apparatus.

FIG. 6B is a view showing the example of the arrangement of the air-intake apparatus.

FIG. 7 is a front view showing the schematic structure of the wafer stage.

FIG. 8A is a view schematically showing an alternative example of a shield member.

FIG. 8B is a view schematically showing another alternative example of the shield member.

FIG. 8C is a view schematically showing still another alternative example of the shield member.

FIG. 8D is a view schematically showing yet another alternative example of the shield member.

### DESCRIPTION OF THE REFERENCE SYMBOLS

25: SAMPLE STAGE (STAGE), 27,27X: LASER INTERFEROMETER (INTERFEROMETER), 28X, 28Y: AIR CONDITIONING APPARATUS (FIRST AIR-CONDITIONING MECHANISM), 29: AIR CONDITIONING APPARATUS (SECOND AIR-CONDITIONING MECHANISM), 34: AIR CONDITIONING APPARATUS (SUPPLY MECHANISM, THIRD AIR-CONDITIONING MECHANISM), 35: AIR-INTAKE APPARATUS (AIR-INTAKE MECHANISM), 38a, 38b: LINEAR MOTOR (DRIVE DEVICE), 39a, 39b: SHIELDING BOX (SHIELD MEMBER, ENCLOSING MEMBER), 41a, 41b: AIR-INTAKE APPARATUS (EXHAUST MECHANISM), 42a, 42b: SHIELDING SHEET (SHIELD MEMBER), 43a, 43b: SHIELDING PLATE (SHIELD MEMBER), 44a, 44b: AIR-INTAKE APPARATUS (EXHAUST MECHANISM), 45a, 45b: SHIELDING PLATE (SHIELD MEMBER), 46a, 46b: SHIELDING SHEET (SHIELD MEMBER), 47a, 47b: SHIELDING SHEET (SHIELD MEMBER), 48a, 48b: SHIELDING PLATE (SHIELD MEMBER), BP: REFERENCE PLANE, EX: EXPOSURE APPARATUS, R: RETICLE (MASK), RST: RETICLE STAGE (MASK STAGE), W: WAFER (SUBSTRATE), WST: WAFER STAGE (STAGE, SUBSTRATE STAGE).

### BEST MODE FOR CARRYING OUT THE INVENTION

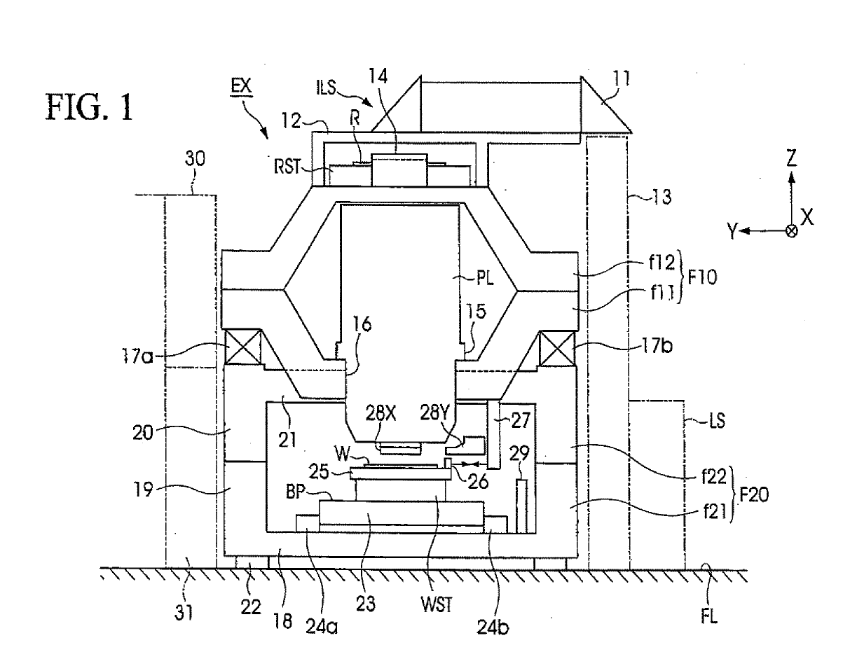

A stage apparatus and an exposure apparatus according to a preferred embodiment of the present invention will now be described with reference to the accompanying drawings. FIG. 1 is a side view schematically showing the general structure of an exposure apparatus according to the preferred embodiment of the present invention. An exposure apparatus EX shown in FIG. 1 is a step-and-scan type scanning exposure apparatus, which transfers a pattern formed on a reticle R sequentially to shot areas on a wafer W through a projection optical system PL while relatively moving the reticle R as a mask and the wafer W as a substrate with respect to the projection optical system PL.

In the following description, an XYZ orthogonal coordinate system is set, and a description is given of the positional relationship of respective members with reference to the XYZ orthogonal coordinate system if necessary. In the XYZ orthogonal coordinate system shown in FIG. 1, the XY plane is set as a plane parallel to the horizontal plane, and the Z axis is set to the vertically upward direction. Further, in the embodiment, a direction in which the reticle R and the wafer W are synchronously moved (scanning direction) is set to the Y direction.

As shown in FIG. 1, the exposure apparatus EX includes a light source LS, an illumination optical system ILS, a reticle stage RST as a mask stage, the projection optical system PL, and a wafer stage WST as a substrate stage. The exposure apparatus EX also includes a main frame F10 and a base frame F20. The reticle stage RST and the projection optical system PL are held in the main frame F10, while the main frame F10 and the wafer stage WST are held in the base frame F20.

The light source LS is, for example, an ArF excimer-laser light source (with 193-nm wavelength). However, any light source other than the ArF excimer-laser light source can be used as the light source LS, such as KrF excimer laser (with 248-nm wavelength), F₂ excimer laser (with 157-nm wavelength), Kr₂ laser (with 146-nm wavelength), an extra high pressure mercury lamp to emit g-line (436-nm wavelength) or i-line (365-nm wavelength) radiation, a YAG-laser high-frequency generator, or a semiconductor-laser high-frequency generator.

The illumination optical system ILS shapes the cross section of laser light emitted from the light source LS and illuminates the reticle R with illumination light the illumination intensity of which is made uniform. This illumination optical system ILS has a housing 11 in which optical components composed of a fly-eye lens as an optical integrator, an aperture field stop, a reticle blind, a relay lens system, a light path bending mirror, a condenser lens system, etc. are arranged in a predetermined positional relationship. This illumination optical system ILS is supported by an illumination system supporting member 12 extending in the vertical direction and fixed on the upper surface of a second frame f12 that forms part of the main frame F10.

Further, the light source LS and an illumination optical system separate part 13 are arranged at the side (−X direction side) of the main body of the exposure apparatus EX separately from the main body of the exposure apparatus EX so that vibration will not be transmitted. The illumination optical system separate part 13 is to guide the laser light emitted from the light source LS to the illumination optical system ILS. Thus, the laser light emitted from the light source LS is incident into the illumination optical system ILS through the illumination optical system separate part 13, and in the illumination optical system ILS, the cross section of laser light is shaped and its illumination distribution is made substantially uniform to generate illumination light to illuminate the reticle.

The reticle stage RST is supported through unillustrated non-contact beatings (for example, gas static pressure bearings) in a floating manner over the upper surface of the second frame f12 that forms part of the main frame F10. This reticle stage RST is comprised of a reticle fine movement stage for holding the reticle R, a reticle coarse movement stage moving integrally with the reticle fine movement stage in the Y axis direction as the scanning direction with a predetermined toke, and a linear motor for moving these stages, A rectangular opening is formed in the reticle fine movement stage, and a reticle suction-holding mechanism provided around the periphery of the opening holds the reticle by vacuum suction or the like. Further, a laser interferometer (not shown) is provided at an end portion on the second frame f12 to detect the X-direction and Y-direction positions of the reticle fine movement stage and a rotation angle around the Z axis with a high degree of precision. Then, based on the measurement results of the laser interference system, the position, attitude, and velocity of the fine movement stage are controlled.

Further, a reticle alignment system 14 is provided to the reticle stage RST. The reticle alignment system 14 is made up by arranging an alignment optical system and an imaging device on a base member to observe a position measuring mark (reticle mark) formed on the reticle R placed on the reticle stage RST. This base member is provided above the reticle stage RST to stride over the reticle stage RST along the X direction as the non-scanning direction, and supported on the second frame f12.

A rectangular opening is provided in the base member provided in the reticle alignment system 14 to allow the illumination light emitted from the illumination optical sys ILS to pass through, and through this opening, the illumination light emitted from the illumination optical system ILS illuminates the reticle R. This base member is made of a non-magnetic material such as austenite stainless steel with consideration given to the electric influence on the linear motor provided in the reticle stage RST.

The projection optical system PL projects a reduced image of a pattern formed on the reticle R onto the wafer W at a predetermined projection magnification β (where β is, for example, ⅕). This projection optical system PL is telecentric on both sides, e.g., on both the object surface side (reticle side) and the image plane side (wafer side). When the illumination light (pulsed light) from the illumination optical system ILS is rated onto the reticle R, an image-forming light flux is incident into the projection optical system PL from a portion of the pan area formed on the reticle R and illuminated with the illumination light so that an inverted partial image of the pattern, which is limited to a slit or rectangular polygonal) shape elongated in the X direction, will be formed at the center of the visual field of the imaging side of the projection optical system PL each time a pulse of the illumination light is radiated. Thus, the projected, inverted partial image of the circuit pattern is reduced in size and transferred to a resist layer in one of a plurality of shot areas on the wafer W arranged on the imaging surface of the projection optical system PL.

A flange 15 is provided around the outer periphery of the projection optical system PL to support the projection optical system PL. This flange 15 is arranged below the center of gravity of the projection optical system PL due to the design restrictions of the projection optical system PL. In response to the demand for finer patterns, the numerical aperture NA of the image plane side of the projection optical system PL is increasing, for example, to 0.9 or more, and with the increase in numerical aperture, the outer diameter and weight of the projection optical system PL are increasing. This projection optical system PL is inserted into a hole portion 16 provided in a first frame f11 that forms part of the main frame F10 and supported through the flange 15.

The second frame f12 for supporting the reticle stage RST and the like is connected on the first frame f11 for supporting the projection optical system PL, thus forming the main frame F10. This main forme F10 is supported on the base frame F20 through vibration damping units 17a, 17b, and 17c (the vibration damping unit 17c is not shown in FIG. 1). Here, the vibration damping units 17a to 17c are arranged at the end portions on an upper frame f22 that forms part of the base frame F20 and constructed by arranging air mounts, whose internal pressure is adjustable, and voice coil motors in parallel on the upper frame f22 of the base frame F20. These vibration damping units isolate, at a micro G level, minute vibration transmitted to the main frame F10 through the base frame F20.

The base frame F20 is comprised of a lower frame f21 and the upper the frame f22. The lower frame f21 is comprised of a floor part 18 for placing the wafer stage WST and columns 19 extending upward a predetermined length from the upper surface of the floor part 18. The floor part 18 and the columns 19 are integrally formed as one unit, rather than coupled by fastening means. The upper frame f22 includes columns 20 provided as many as the columns 19, and be parts 21 for connecting the upper portions of the columns 20, respectively. The columns 20 and the beam parts 21 are integrally formed as one unit, rather an coupled by fastening means or the like. The columns 19 and the columns 20 are fastened with bolts or the like. Thus, the base frame F20 has a rigid frame sure that can improve rigidity. The base frame, F20 thus constructed is installed almost horizontally on the floor FL in a clean room or the like through foot parts 22.

The wafer stage WST is located inside the base frame F20, and placed on the lower frame f21 through a wafer stage base 23. A reference plane BP is formed on the wafer stage base 23 along the XY plane. The wafer stage WST is placed on the reference plane BP so that it can move two-dimensionally with a predetermined range along the reference plane BP. This wafer stage base 23 is supported almost horizontally through vibration damping units 24a, 24b, and 24c (the vibration damping unit 24c is not shown in FIG. 1). Here, the vibration damping units 24a to 24c are arranged, for example, at three end portions on the wafer stage base 23 and constructed by arranging air mounts, whose internal pressure is adjustable, and voice coil motors in parallel on the lower frame f21 that forms par of the base frame F20. These vibration damping units isolate, at a micro G level, minute vibration transmitted to the wafer stage base 23 trough the base frame F20.

Further, a sample stage 25 is provided on the top of the wafer stage WST in such a manner to be integrally formed with the wafer stage WST to suction-hold the wafer W. This sample stage 25 finely drives the wafer W with three degrees of freedom in the Z axis direction, a θx direction (rotation direction about the X axis), and a θy direction (rotation direction about the Y axis) to perform leveling of and focusing on the wafer. Further, a drive device (not shown in FIG. 1) such as, for example, a linear motor, is provided in the wafer stage WST, and this linear motor continuously moves the wafer stage WST in the Y direction while step-moving it in the X and Y directions. Further, a counter mass is provided in the wafer stage WST in such a manner to move in a direction opposite to the moving direction of the wafer stage WST in order to cancel a reaction force generated upon driving of the stage.

A moving mirror 26 is attached to one end portion of the top of the sample stage 25 provided on the wafer stage WST, while a fixed mirror, not shown, is attached to the above-mentioned projection optical system PL. A laser interferometer 27 radiates laser light to the moving mirror 26 and the fixed mirror, not shown, to detect the X- and Y-direction positions of the wafer stage WST, and a rotation angle around the Z axis with a high degree of precision. This laser interference system splits, into two laser beams, the laser light including two linearly-polarized beams whose polarization directions are orthogonal to each other to radiate one laser beam to the moving mirror 26 and the other laser beam to the fixed mirror, not shown, in order to detect interference light obtained by causing interference between the laser beams reflected by the moving mirror 26 and the fixed mirror, respectively thereby obtaining position information of the wafer stage WST.

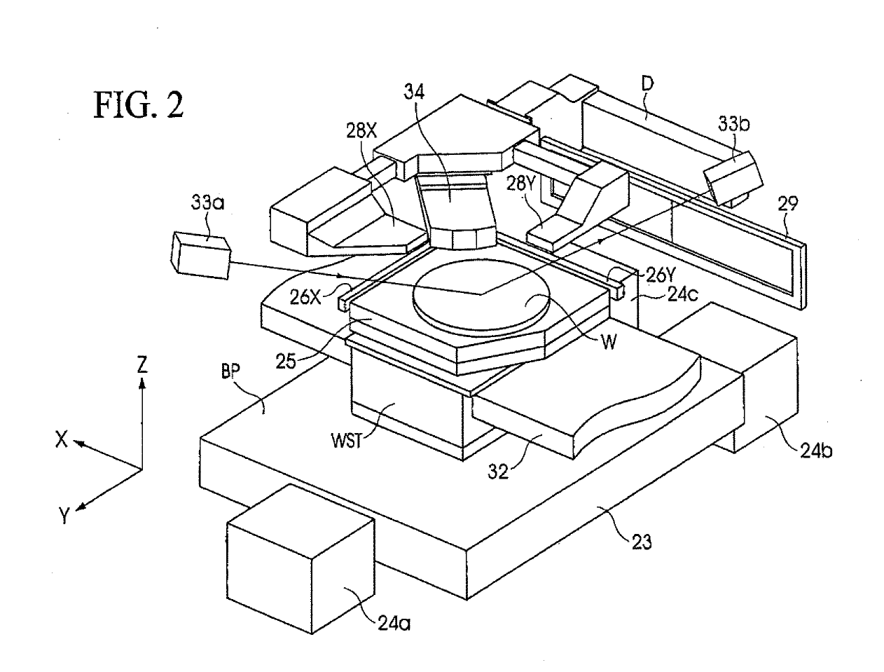

Although shown schematically in FIG. 1, the moving mirror 26 consists of a moving mirror 26X having a mirror surface perpendicular to the X axis and a moving mirror 26Y having a mirror surface perpendicular to the Y axis (see FIG. 2). Further, the laser interferometer 27 consists of two Y-axis laser interferometer for irritating laser beams to the moving mirror 26 along the Y axis and two X-axis laser interferometers for irradiating laser beams to the moving mirror 26 in the X axis. In this structure, one Y-axis laser interferometer and one X-axis laser interferometer measure the X and Y coordinates of the water stage WST. On the other hand, the other X-axis or Y-axis laser interferometer measures the rotation about the X-axis. Further, these laser interferometers measure the rotation of the wafer stage WST about the X axis and the Y axis. Note that the laser interferometer shown in FIG. 1 corresponds to a laser interferometer 27Y for irradiating the laser beam to the moving mirror 26Y having the mirror surface perpendicular to the Y axis.

Further, air conditioning apparatuses 28X and 28Y as a first air-conditioning mechanism are arranged above (in +Z direction of) the light path of the laser light radiated from the laser interferometer 27. The air conditioning apparatuses 28X and 28Y are to supply temperature-controlled air with a constant temperature at a constant flow rate from the upward direction (+Z direction) to the downward direction (−Z direction) with respect to the light path of the laser light radiated from the laser interferometer 27 to the moving mirror 26 and the fixed mirror, not shown. In the following description, the temperature-controlled air supplied by the air conditioning apparatuses 28X and 28Y from the upward direction (+Z direction) to the downward direction (−Z direction) with respect to the light path of the laser light is referred to as “down flow.” The temperature of this down flow is controlled, for example, within a range of ±0.005° C. to a set temperature.

Further, an air conditioning apparatus 29 as a second air-conditioning mechanism is provided in the −Y direction of the wafer stage WST. This air conditioning apparatus 29 supplies temperature-controlled air with a constant temperature into a space between the light path of the laser light radiated from the laser interferometer 27 to the moving mirror 26 and the wafer stage base 23 at a constant flow rate from the −Y direction to the +Y direction. In the following description, the temperature-controlled air supplied by the air conditioning apparatus 29 into the space between the light path of the laser light and the wafer stage base 23 from the −Y direction to the +Y direction is referred to as “lower side flow.” The temperature of the lower side flow supplied from the air conditioning apparatus 29 is controlled, for example, within a range of ± 1/100° C. to a set temperature.

Although not shown in FIG. 1, the exposure apparatus of the embodiment is provided with an off-axis wafer alignment sensor at a lateral side of the projection optical system PL. This wafer alignment sensor is an FIA (Field Image Alignment) type alignment sensor, which is to measure position information of a position measuring mark (alignment mark) in the X and Y directions formed on the wafer W in such a manner that a light flux having a broad-band wavelength emitted from, for example, a halogen lamp is radiated as a sensing beam onto the wafer W, the reflected light from the wafer W is image-captured by an image pickup device such as a CCD (Charge Coupled Device), and the resulting image signal is subjected to image processing.

Further, an oblique incidence type autofocus sensor (AF sensor) is placed at the side of the projection optical system PL to detect the position of the wafer W in the Z axis direction, and the rotation about the X axis and the Y axis. This AF sensor is comprised of an irradiation optical system 33a (see FIG. 2) for projecting a slit image to a plurality of measuring points preset within an exposure area on the wafer W to which an image of the retile R is to be project, and a light-receiving optical system 33b for receiving the reflected light of the slit image from the measuring points and re-imaging these slit images to generate a plurality of focus signals corresponding to lateral shifts of the re-formed slit images, respectively. From the lateral shift of the slit image at each detection point, the position of the wafer W in the Z axis direction, and the rotation of the wafer W about the X axis and Y axis are detected.

Further, a reticle loader 30, a wafer loader 31, a control system (not shown), etc. are arranged in the +Y direction of the exposure apparatus EX. A coater/developer, which is comprised of a coater for coating a photoresist to the wafer W and a developer for performing development processing on the wafer W after subjected to exposure processing by the exposure process EX, may also be arranged in the +Y direction in which the reticle loader 30, the wafer loader 31, etc. are arranged.

The air conditioning apparatuses 28X, 28Y, and 29 will next be described in detail. FIG. 2 is a perspective view showing the schematic structure of the wafer stage WST. Note that in FIG. 2 the same members as those shown in FIG. 1 are given the same reference numerals and symbols. As shown in FIG. 2, the wafer stage base 23 is supported almost horizontally through the vibration damping units 24a, 24b, and 24c, and the wafer stage WST is provided on this wafer stage base 23 in such a manner that it can move within a predetermined moving range across the upper surface (reference plane BP) of the wafer stage base. The linear motor is provided inside this wafer stage WST to drive the wafer stage to move in the X direction along an X guide bar 32.

As shown in FIG. 2, the air conditioning apparatus 28X is arranged above the light path of the laser light radiated to the moving mirror 26X attached to the sample stage 25 on the wafer stage WST, while the air conditioning apparatus 28Y is arranged above the light path of the laser light radiated to the moving mirror 26Y. The air conditioning apparatus 28X supplies the down flow, whose temperature is controlled for example, within the range of ±0.005° C. to the set temperature, at the constant flow rate toward the light path of the laser light radiated from the laser interferometer 27 to the moving mirror 26X and the fixed mirror, not shown. On the other band, the air conditioning apparatus 28Y supplies the down flow, whose temperature is controlled, for example, with the range of ±0.005° C. to the set temperature, at the constant flow rate toward the light path of the laser light radiated from the laser interferometer 27 to the moving mirror 26Y and the fixed mirror, not shown.

The air conditioning apparatus 29 is set to have a length substantially corresponding to the movable range of the wafer stage WST in the X direction, so that the lower side flow is supplied from the air conditioning apparatus 29 into the space between the light path of the laser light radiated from the laser interferometer 27 to the moving mirrors 26X, 26Y and the wafer stage base 23, with a width wider than the width of the wafer stage WST in the X direction. This air conditioning apparatus 29 supplies the lower side flow substantially in parallel to this space in the +Y direction. The air conditioning apparatuses 28X and 29Y, and the air conditioning apparatus 29 individually control the temperature of the air supplied through a duct D to generate the down flow and the lower side flow, respectively.

The down flow is supplied by the air conditioning apparatus 28X toward the light path of the laser light radiated from the laser interferometer 27 to the moving minor 26X and the fixed mirror, not shown, form a direction substantially orthogonal to the light path. The down flow is supplied by the air conditioning apparatus 28Y toward the light path of the laser light radiated from the laser interferometer 27 to the moving mirror 26X and the fixed mirror, not shown, from a direction substantially orthogonal to the light path. Further, the lower side flow is supplied by the air conditioning apparatus 29 into the space between the light path of the laser light and the reference plane BP of the wafer stage base 23 along the reference plane BP (along the Y direction in the embodiment).

Here, the air conditioning apparatuses 28X and 28Y are provided for supplying the down flow toward the light path of the laser light radiated from the laser interferometer 27 to the moving mirrors 26X, 26Y and the fixed mirror, not show to prevent the degradation of detection accuracy due to air fluctuation caused by heat generated from heat sources (e.g., linear motor) provided around the wafer stage WST. However, if the maximum velocity of the wafer stage WST is pushed up, detection accuracy may be degraded.

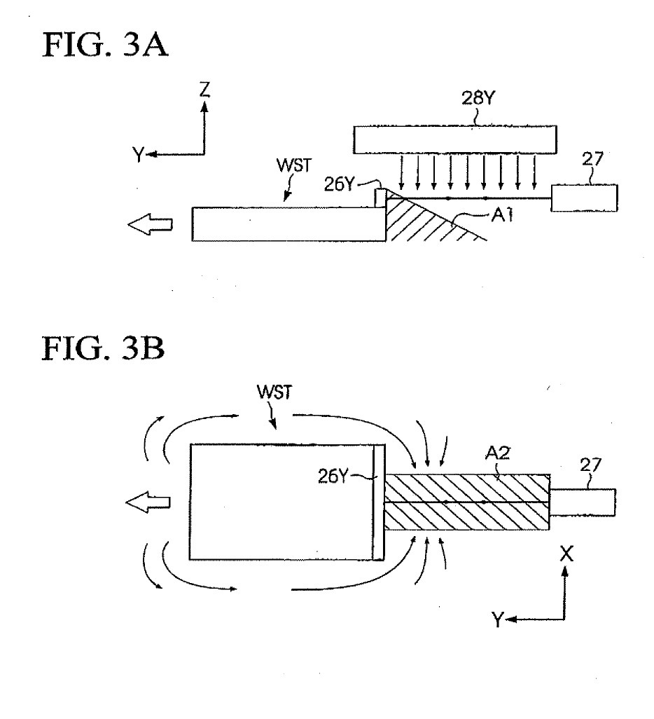

FIGS. 3A and 3B are views for explaining the degradation of the detection accuracy of the laser interferometer due to an increase in the speed of the wafer stage WST. FIG. 3A is a side view of the wafer stage WST, and FIG. 3B is a plan view of the wafer stage WST. Note that in FIGS. 3A and 3B, the wafer stage WST, the laser interferometer 27, and the air conditioning apparatus 28Y are schematically shown. As shown in FIG. 3A, when the wafer stage WST is moved in the +Y direction, a positive pressure is generated on the side of traveling direction of the wafer stage WST (i.e., +Y side of the wafer stage WST), whereas a negative pressure is generated on the −Y side of the wafer stage WST. In FIG. 3A, an area A1 where the negative pressure is generated is indicated by diagonal hatched lines. This area A1 extends further in the Y direction as the maximum velocity of the wafer stage WST increases.

Then, when a pressure difference occurs between both ends of the wafer stage WST in the Y direction, air on the +Y side of the wafer stage WST where the positive pressure is generated is mixed in the −Y side of the wafer stage WST where the negative pressure is generated as shown in FIG. 3B. An area A2 indicated by diagonal hatched lines in FIG. 3B is a schematically shown area to which the down flow is supplied. Here, since no air conditioning apparatus is provided on the +Y side of the wafer stage WST, the air on the +Y side of the wafer stage WST is temperature-uncontrolled air. Therefore, the temperature uncontrolled air on the +Y side of the wafer stage WST is mixed with the air on the −Y side of the wafer stage WST, where the temperature of the air is controlled by the air conditioning apparatus 28Y to cause air fluctuation due to a temperature difference, resulting in degradation of the detection accuracy of the laser interferometer 28Y.

On the other hand, when the wafer stage WST is moved in the −Y direction, a phenomenon opposite to the above case occurs to generate the positive pressure on the −Y side of the wafer stage WST and the negative pressure on the +Y side of the wafer stage WST. In this case, since the air conditioning apparatus 28Y is provided on the −Y side of the wafer stage WST, air on the −Y side of the wafer stage WST is pressed down in the downward direction (−Z direction) to flow into an area where the negative pressure is generated on the +Y side of the wafer stage WST through the lateral sides of the wafer stage WST.

However; if the moving speed of the wafer stage WST in the −Y direction is close to the flow rate of the down flow, part of the temperature-uncontrolled air mixed in the −Y side of the wafer stage WST is pressed down by the end portion of the wafer stage WST on the −Y side and hence stays behind. In other words, although almost the entire section of the light path of the laser light radiated from the laser interferometer 27 to the moving mirror 26Y is supplied with the down flow from the air conditioning apparatus 28Y, the temperature-uncontrolled air stays behind in the vicinity of the moving mirror 26Y, and this causes the degradation of detection accuracy of the laser interferometer 27. Further, as mentioned above, when the wafer stage WST is moved in the +Y direction, the area A1 where to negative pressure is generated extends her in the Y direction as the maximum velocity of the wafer stage WST increases. Therefore, even when the wafer stage WST is moved in the −Y direction, the amount of temperature-uncontrolled air that stays behind in the end portion of the wafer stage WST on the −Y side increases.

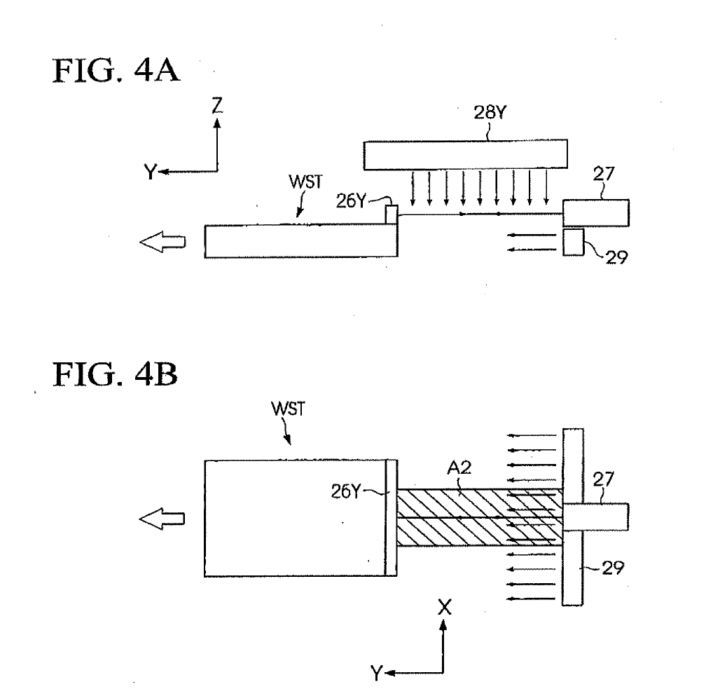

The exposure apparatus EX of the embodiment deals with the above problems by providing the air conditioning apparatuses 28X, 28Y and the air conditioning apparatus 29 in combination to supply the down flow toward the light path of the laser light radiated from the laser interferometer 27 to the moving mirror 26X, 26Y and the fixed mirror, not shown, and the lower side flow into the space under the light path of the laser light. Here, if a side flow of gas is supplied across the light path of the laser light to which the down flow is being supplied, the flow of air in the light path can be disturbed, resulting in more degradation of the measurement accuracy of the interferometer. This is why the gas is supplied across the space under the light path of the laser light in the embodiment. FIGS. 4A and 4B are views for explaining the effects of use of the down flow and the lower side flow in combination. FIG. 4A is a side view of the wafer stage WST, and FIG. 4B is a plan view of the wafer stage WST. Note that in FIGS. 4A and 4R, the wafer stage WST, the laser interferometer 27, and the air conditioning apparatus 28Y are schematically. The area A indicated by diagonal hatched lines in FIG. 4B is a schematically shown area to which the down flow is supplied.

As shown in FIGS. 4A and 4B, the side flow is supplied from the air conditioning apparatus 29 into the space under the light path of the laser light radiated from the laser interferometer 27 to the moving mirror 26Y with a width wider than the width of the wafer stage WST in the X direction. As a result, stagnant air around the wafer stage WST is blown off in the +Y direction. Therefore, when the wafer stage WST is moved in the +Y direction, even if the positive pressure is generated on the +Y side of the wafer stage WST and the negative pressure is generated on the −Y side, the air coming into the −Y side of the wafer stage WST through both sides of the wafer stage WST is blown off by the lower side flow, and the temperature-controlled air is supplied instead from the air conditioning apparatus 29 to the −Y side of the wafer stage WST. Thus, the air directed from the lower side to the upper side of the end portion of the wafer stage WST on the −Y side can be made to be temperature-controlled air, thereby preventing the degradation of detection accuracy of the laser interferometer 27.

On the other hand, when the wafer stage WST is moved in the −Y direction, although the positive pressure is generated on the −Y side of the wafer stage WST and the negative pressure is generated on the +Y side, the air on the −Y side of the wafer stage WST flows toward the side of the wafer stage WST in the X direction through the down flow from the air conditioning apparatus 28Y and the lower side flow from the air conditioning apparatus 29. Therefore, even in the unlikely event that the temperature-uncontrolled air is mixed in the −Y side of the wafer stage WST, this air can be removed. Thus, the degradation of detection accuracy of the laser interferometer 27 can be prevented.

Returning to FIG. 2, the irradiation optical system 33a that forms par of the AF sensor is arranged in a direction 45 degrees to each of the +X direction and the +Y direction from a detection area set in the exposure area, and the light-receiving optical system 33b is arranged 45 degrees to each of the −X direction and the −Y direction from the detection area. Further, an air conditioning apparatus 34 as a third air-conditioning mechanism is arranged 45 degrees to each of the +X direction and the −Y direction from the detection area set in the exposure area. This air conditioning apparatus 34 is to supply temperature-controlled air with a constant temperature toward the wafer stage WST (sample stage 25) at a constant flow rate flora an obliquely upper direction. Thus, the temperature-controlled air is supplied from the AF sensor toward the light path of the slit image projected to a detection area on the wafer W. The temperature of the temperature-controlled air supplied from is air conditioning apparatus 34 is controlled, for example within the range of 0.005° C. to the set temperature. This air conditioning apparatus 34 controls the temperature of air supplied trough the duct D to generate, the temperature-controlled air.

Here, the air conditioning apparatus 34 is provided for the following reason: If the movement of the wafer stage WST in the +Y direction and the movement thereof in the −Y direction are alternated, air built-up on the negative pressure side in the +Y direction or −Y direction of the wafer stage WST is rolled up from the upper surface of the wafer stage WST. As mentioned above, although the lower side flow is supplied from the air conditioning apparatus 29 into the space between the laser light and the reference plane BP, the temperature of the supplied air slightly varies during flowing over the reference plane BP. Therefore, if the air whose temperature has varied is rolled up from the upper surface of the wafer stage WST, air fluctuation will occur in the light path of the AF sensor, resulting in degradation of detection accuracy. This is why the exposure apparatus of the embodiment is provided with the air conditioning apparatus 34. Even if the air is rolled up from the reference plane BP along with the movement of the wafer stage WST, since the down flow is supplied from the air conditioning apparatuses 28X and 28Y toward the light path of the laser interferometer 27, the incidence of air fluctuation can be suppressed.

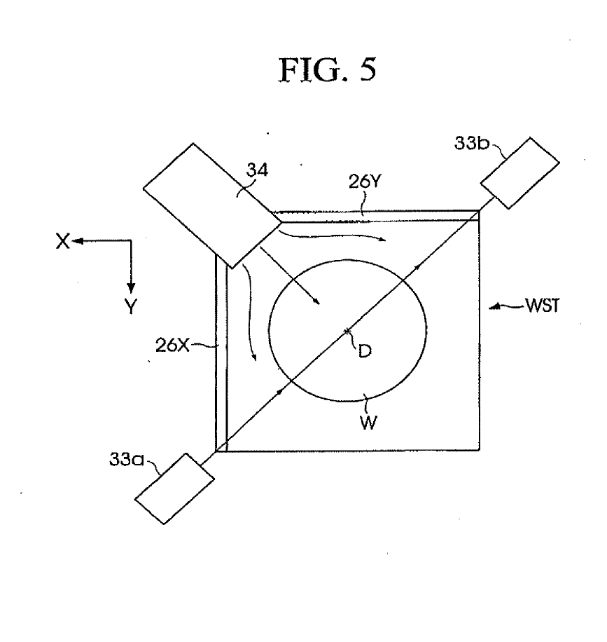

FIG. 5 is a view for explaining conditioned air supplied over the wafer stage WST from the air conditioning apparatus 34. As shown in FIG. 5, the air conditioning apparatus 34 is arranged in a plan view on a straight line intersecting the light path of the slit image projected from the AF sensor to supply the temperature-controlled air to spread from substantially the center of the detection area set on the wafer W (represented as a detection point D in FIG. 5) over the wafer stage WST. The temperature-controlled air is supplied in ails way for the purpose of eliminating the air rolled up from the wafer stage WST as much as possible.

In other words, when the wafer stage WST is moved in the +X direction air that has jumped over the moving mirror 26X and is present on the reference plane BP is rolled up from the wafer stage WST, while when the wafer stage WST is moved in the −Y direction, air that has jumped over the moving mirror 26Y and is present on the reference plane BP is rolled up from the wafer stage WST. If the temperature-controlled air from the air condition apparatus 34 flows only toward the detection area, the air that has jumped over the moving mirrors 26X and 26Y is caught in the flow of this temperature-controlled air and directed toward the detection area. As a result, air fluctuation occurs within or in the neighborhood of the detection area due to a temperature difference.

However, as shown in FIG. 5, if the temperature-controlled air from the air conditioning apparatus 34 is supplied to spread over the wafer stage WST, since the temperature-uncontrolled air that has jumped over the moving mirrors 26X and 26Y can be blown off outside of the wafer stage WST through the flow of this temperature-controlled air, the degradation of detection accuracy of the AF sensor can be prevented. On the other hand, when the wafer stage WST is moved in the −X direction, the air rolled up from the end portion of the wafer stage WST in the −X direction of the wafer stage WST can be blown off in the −X direction through the flow of the temperature-controlled air from the air conditioning apparatus 34. Similarly, when the wafer stage WST is moved in the +X direction, the air rolled up from the end portion of the wafer stage WST in the +Y direction of the wafer stage WST can be blown off in the +Y direction through the flow of the temperature-controlled air from the air conditioning apparatus 34.

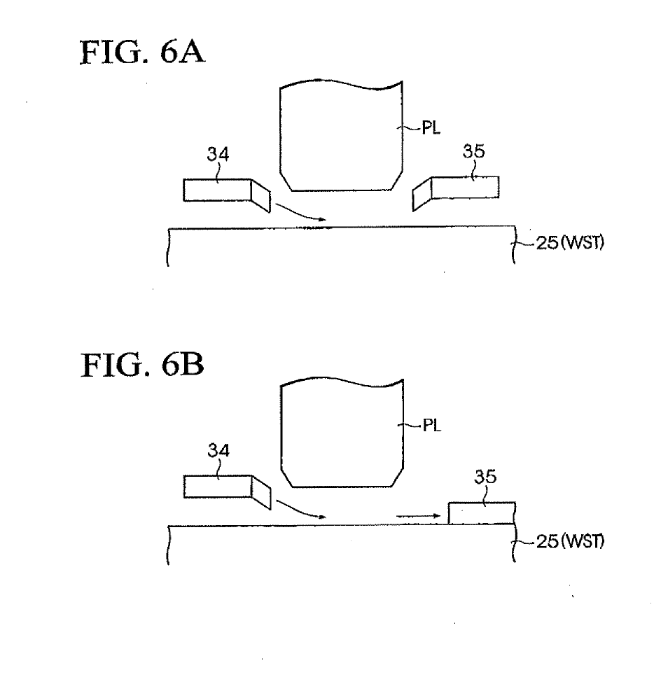

If the air conditioning apparatus 34 has to be arranged at a position far from the wafer stage WST for some reason of the apparatus structure, the temperature-controlled air may not be supplied sufficiently to the detection area of the AF sensor depending on the position of the wafer stage WST. In this case, it is desirable to provide an air-intake apparatus 35 for sucking in the temperature-controlled air from the air conditioning apparatus 34. FIGS. 6A and 6B are views showing examples of the arrangement of the air-intake apparatus 35. This air-intake apparatus 35 is arranged to face the air conditioning apparatus 34 at 45 degrees with respect to each of the −X direction and the +Y direction from the detection area. In the example shown in FIG. 6A, it is provided at the side of the projection optic system PL and above the wafer stage WST, while in the example shown in FIG. 6B, it is attached on the wafer stage WST (on the sample stage 25).

Since the air-intake apparatus 35 is provided, a flow of the temperature-controlled air supplied from the air conditioning apparatus 34 can be directed toward the air-intake apparatus 35 through a gap between the upper surface of the wafer stage WST and the projection optical system PL. Further, the generation of this flow can keep, at a certain level or more, the flow rate of the temperature controlled air passing between the upper surface of the wafer stage WST and the projection optical system PL, so that contamination of the projection optical system PL (contamination of an optical element provided at the tip of the projection optical system PL) due to, for example, volatilization of the resist coated on the wafer W can be prevented. Further, when this air-intake apparatus 35 is provided, the air rolled up from the wafer stage WST during movement of the wafer stage WST can be evacuated promptly. On the other hand, when the air-intake apparatus 35 is provided on the water stage WST (on the sample stage 25) as shown in FIG. 6B, it is desirable to change the air-intake direction according to the position of the wafer stage WST. In this case, an air rectifying blade has to be provided at an inlet of the air-intake apparatus 35 in such a manner to direct the air rectifying blade toward the air conditioning apparatus 34 according to the position of the wafer stage WST measured by the laser interferometer 27.

As described above, in the exposure apparatus EX of the embodiment, the air conditioning apparatuses 28X and 28Y for supplying the down flow toward the light path of the laser light radiated from the laser interferometer 27, the air conditioning apparatus 29 for supplying the lower side flow into the space below the light path, and the air conditioning apparatus 34 for supplying the temperature-controlled air over the wafer stage WST. The combination of these air conditioning apparatuses serve to maintain the detection accuracy of the laser interferometer 27 and the AF sensor. Here, in order to maintain the detection accuracy of the laser interferometer 27 and the AF sensor, it is necessary to define the relationship among wind velocities of the temperature-controlled air supplied from the air conditioning apparatuses, respectively.

Specifically, if the wind velocity of the temperature-controlled air from the air conditioning apparatuses 28X and 28Y is expressed as V_{D}, the wind velocity of the temperature-controlled air from the air conditioning apparatus 29 is V_{S}, and the wind velocity of the temperate-controlled air from the air conditioning apparatus 34 is V_{U}, the wind velocity supplied from each temperature control apparatus is set to establish the relation shown in the following equation (1):

V_{D}≧V_{U}≧V_{S} (1)

In other words, the wind velocity is so set that the wind velocity V_{D} of the temperature-controlled air from the air conditioning apparatuses 28X and 28Y becomes equal to or higher than the wind velocity V_{U} of the temperature-controlled air from the air conditioning apparatus 34, and the wind velocity V_{U} of the temperature-controlled air from the air conditioning apparatus 34 becomes equal to or higher than the wind velocity V_{S} of the temperature-controlled air from the air conditioning apparatus 29. This setup makes it possible to maintain the detection accuracy of both the laser interferometer 27 and the AF sensor.

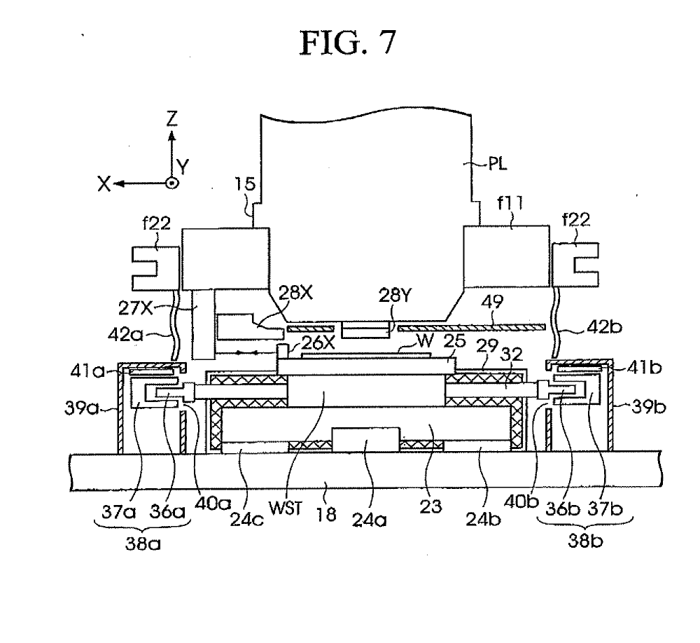

FIG. 7 is a front view showing the schematic structure of the wafer stage WST. Note that in FIG. 7 the same members as those shown in FIGS. 1 to 6B are given the same reference numerals and symbols. As shown in FIG. 7, the X guide bar 32 extending in the X direction is provided in the wafer stage WST. The wafer stage WST can be moved along the X guide bar 32 by driving the linear motor, not shown, provided inside the wafer stage WST.

A mover 36a comprised of an armature unit is attached to one end of the X guide bar 32 in the +X direction, while a mover 36b comprised of an armature unit is attached to the other end in the −Y direction. Further, a stator 37a comprised of a magnet unit is provided in association with the mover 36a, while a stator 37b comprised of a magnet unit is provided in association with the mover 3b. Here, the structure in which the movers 36a and 36b include the armature units and the stators 37a and 37b include the magnet units is taken as an example, but the structure can be such that the movers 36a and 36b include the magnet units and the stators 37a and 37b include the armature units, respectively.

The armature units provided in the movers 36a and 36b are constructed by disposing, for example, a plurality of coils at predetermined intervals in the Y direction, while the magnet units provided in the stators 37a and 37b are constructed by disposing a plurality of magnets in the Y direction at intervals corresponding to the arrangement intervals of the coils provided in the movers 36a and 36b. The stators 37a and 37b have a length equal to or longer than at least the movable range of the wafer stage WST in the Y direction. The magnets provided in the magnet unit are disposed in such a manner magnetic poles are alternated along the Y direction to form an alternating magnetic field in the Y direction. Thus, the current supplied to the coils provided in the movers 36a and 36b is controlled according to the position of the stators 37a and 37b, enabling continuous generation of thrust.

The linear motor 38a as the driving unit is construct of the above-mentioned mover 36a and stator 37a, while the linear motor 38b is constructed of the above-mentioned mover 36b and stator 37b. If the amounts of driving of these linear motors 38a and 38b are made equal, the wafer stage WST can be translated along the Y direction, while if they are made different, the wafer stage WST can be finely rotated around the Z axis. The linear motors 38a and 38b are provided at both ends of the wafer stage WST in the X direction, at is, outside of the movable range of the wafer stage WST. Here, the reasons for providing the linear motors 38a and 38b at both ends of the wafer stage WST in the X direction are that large thrust is necessary to move the wafer stage WST because of the need to move both the wafer stage WST and the X guide bar 32 during movement of the wafer stage WST, and that the scanning direction is set to the Y direction.

The exposure apparatus of the embodiment includes shielding boxes 39a and 39b as enclosing members or shield members for enclosing the linear motors 38a 38b constructed as mentioned above, respectively. Each of the shielding boxes 39a and 39b is to shield (isolate) the space where each of the linear motors 38a and 38b is disposed from the space where the wafer stage WST is arranged. Since the maximum velocity of the wafer stage WST is set high in order to improve throughput, the amount of heat generated from the linear motors 38a and 38b is large. The shielding boxes 39a and 39b are provided to prevent the occurrence of air fluctuation due to heat generated from the linear motors 38a and 38b in the space where the wafer stage WST is arranged.

The shielding boxes 39a and 39b are ceramics or vacuum insulation panels having heat insulation properties, and made of a material (chemically-clean material) which hardly ever causes chemical contaminants that contaminate the inside of a chamber, not shown, in which the exposure apparatus is housed. Each of the shielding boxes 39a and 39b has a rectangular shape elongated in the Y direction along each of the linear motors 38a and 38b, respectively, and notch portions 40a and 40b are formed to extend in the Y direction on respective sides to fine the wafer stage WST in order to make the movers 36a and 36b movable in the Y direction.

Further, the exposure apparatus of the embodiment includes a temperature-controlled top board 49 between the wafer stage WST and the first frame f11. The temperature-controlled top board 49 is made of a plate-shaped metal (e.g., a material having high thermal conductivity such as aluminum) with a fluid flow path formed therein. A temperate-controlled fluid, whose temperature is controlled to remain constant, flows tough the inside flow path. Thus, the temperature of the temperature-controlled top board 49 is kept constant so that the temperature of the space, where the wafer stage WST is arranged, can be kept constant even if the temperature of the first formed f11 varies. In other words, the temperature-controlled top board 49 is provided also to prevent the occurrence of air fluctuation in the space where the wafer stage WST is arranged. The temperature-controlled top board 49 has notches provided in portions where the air conditioning apparatuses 28X and 29Y arranged and a portion though which exposure light from the projection optical system PL passes.

In order to shield the space where the linear motor 38a or 38b is disposed from the space where the wafer stage WST is arranged, the shielding boxes 39a and 39b have only to be provided. However, since the maximum velocity of the wafer stage WST is set high to meet the need for high throughput, the amount of heat generated by the linear motors 38a and 38b increases. For this reason, it is desirable to provide air-intake apparatuses 41a and 41b for the shielding boxes 39a and 39b, respectively, in order to exhaust the air from the shielding boxes 39a and 39b to the outside. In FIG. 7, although the air-intake apparatuses 41a and 41b are provided above the linear motors 39a and 38b, respectively, this arrangement is just an illustrative example, and the air-intake apparatuses 41a and 41b can be arranged at any other positions as long as they are located inside the shielding boxes 39a and 39b, respectively. Further, the air-take apparatuses 41a and 41b can be provided outside of the shielding boxes 39a and 39b, respectively, in such a manner that only inlets connected to the air-intake apparatuses 41a and 41b are provided inside the shielding boxes 39a and 39b, respectively.

Further, shielding sheets 42a and 42b as shield members are provided above the shielding boxes 39a and 39, respectively. Each of the shielding sheet 42 and 42b is to shield (isolate) the space where ea of the linear motors 38a and 38b is disposed from the space where the wafer stage WST is arranged. Thus, each of the above-mentioned shielding boxes 39a and 39b shields between the space where the wafer stage WST is arranged and the space where each of the linear motors 38a and 38b is disposed. In addition, the shielding sheets 42a and 42b are provided considering, for example, such a case that heat is released from the upper surface of the shielding boxes 39a and 39b, or heat is generated from heat sources other than the linear motors 38a and 38b.

The shielding sheets 42a and 42b are fluorine-based sheets such as Teflon™ or fluorine-based rubber, which has heat insulation properties and is made of a chemically-clean material. It is preferable that the shielding sheets 42a and 42b further have flexibility. The wafer stage WST can be enclosed with a heat-insulating material having high rigidity only for the purpose of shielding between the space where the wafer stage WST is arranged and the space where each of the linear motors 38a and 38b is disposed. In such a structure, however, the maintainability of the wafer stage WST, etc. is reduced. As shown in FIG. 7, the structure in which the linear motors 38a and 38b are covered by the shielding boxes 39a and 39b and the shielding sheets 42a and 42b having flexibility are arranged above the shielding boxes 39a and 39b, respectively, can not only shield between the space where the wafer stage WST is arranged and the space where each of the linear motors 39a and 38b is disposed, but also prevent reduction in maintainability.

The shielding sheets 42a and 42b are attached to the upper frame 122 that forms part of the base frame F20 in such a manner to hang down from the upper frame f22 toward each of the shielding boxes 39a and 39b. Since the shielding boxes 39a, 39b and shielding sheets 42a, 42b are constructed as mentioned above, the laser interferometer 27X is arranged in the space where the wafer stage WST is arranged as shown in FIG. 7 and shielded from the space where each of the linear motors 38a and 38b is disposed. Similarly, the laser interferometer 27Y and the AF sensor are shielded from the space where each of the linear motors 38a and 38b is disposed, respectively. This structure makes it possible to maintain the detection accuracy of the laser interferometer 27 (in FIG. 7, the interferometer 27X for irradiating laser light to the moving mirror 26) provided in the space where the wafer stage WST is arranged, and the detection accuracy of the AF sensor provided above the wafer stage WST.

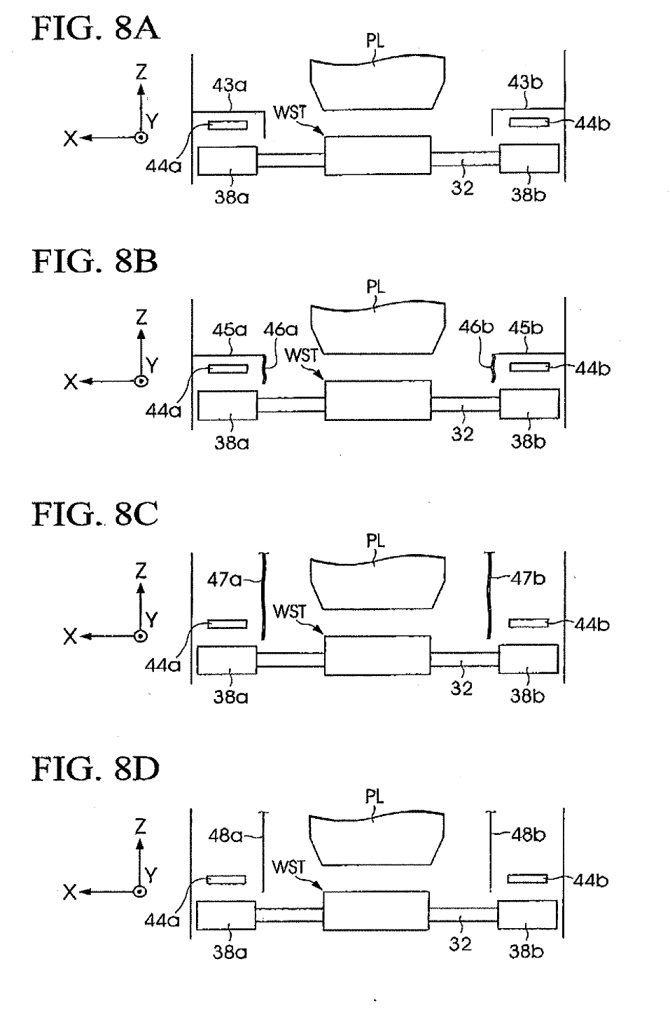

In FIG. 7, the shielding boxes 39a and 39b are provided for shielding the linear motors 38a and 38b, respectively, and the shielding sheets 42a and 42b are provided above the shielding boxes 39a and 39b, but shield members other than those shown in FIGS. 3A and 3B can be used to shield between the space where the wafer stage WST is arranged and the space where each of the linear motors 38a and 38b is disposed. FIGS. 8A to 8D are views schematically showing alternative examples of the shield members.

In FIG. 7, the shielding boxes 39a and 39b are provided to enclose the linear motors 38a and 38b, respectively, except for the notch portions 40a and 40b. However, as shown in FIG. 8A, the structure can be such that shaped shielding plates 43a and 43b are provided to cover only the upside portions of the linear motors 38a and 38b, respectively, and the air-intake apparatuses 44a and 44b are provided between the shielding plates 43a, 43b and the linear motors 38a, 38b, respectively. Like the shielding boxes 39a and 39b, the shielding plates 43a and 43b are ceramics or vacuum insulation panels having heat insulation properties, which are made of a chemically-clean material. In such a structure, air warmed by heat from the linear motors 38a and 38b is trapped inside the shielding plates 43a and 43b, and exhausted to the outside.

Further, instead of the L-sped shielding plates 43a and 43b shown in FIG. 8A, the shield member structure can be comprised of plate-like shielding plates 45a, 45b and shielding sheets 46a, 46b each attached to one end of each of the shielding plates 45a, 45b as shown in FIG. 8B. The plate-like shielding plates 45a and 45b are arranged above the linear motors 38a and 38b substantially in parallel to the XY plane, respectively, and each of the shielding sheds 46a and 46b is attached to one end of each of the shielding plates 45a and 45b on the side to face the wafer stage WST. Here, it is desirable that the shielding sheets 46a, 46b be made of the same material as the shielding sheets 42a and 42b.

Further, as shown in FIG. 8C, shielding sheets 47a and 47h can be attached to the upper frame 122 that forms part of the base frame F20 shown in FIGS. 1 and 7 in such a manner to hang down toward a position above and near the X guide bar 32. The shielding sheets 47a and 47b are made of the same material as the shielding sheets 42a and 42b, and the length of in the Y direction is set longer than the length of the linear motors 38a and 38b in the Y direction to shield between the space where the wafer stage WST is arranged and the space where each of the liar motors 38a and 38b is disposed. This structure can reduce the costs of the shield members. Note that it is desirable to provide the air-intake apparatuses 44a and 44b in the space where each of the linear motors 38a and 38b is disposed respectively.

Further, as shown in FIG. 8D, shielding plates 48a and 48b can be provided instead of the shielding sheets 42a and 42b shown in FIG. 8C. The shielding plates 49a and 48b are also attached to the upper frame f22 that forms part of the base frame F20 in such a manner to hang down toward the position above and near the X guide bar 32. The shielding plates 48a and 48b are made of the same material as the shielding boxes 39a and 39b. Like in the structure shown in FIG. 8C, this structure can also shield between the space where the wafer stage WST is arranged and the space where each of the linear motors 38a and 38b is disposed. However, the shielding plates 48a and 48b in the structure shown in FIG. 8B need to be detached upon maintenance work on the wafer stage WST from +X side or −Y side. In the structure shown in FIG. 8D, it is also desirable to provide the air-intake apparatuses 44a and 44b in the space where each of the linear motors 38a and 38b is disposed, respectively.

Upon transfer of a pattern formed on the reticle R onto the wafer W using the exposure apparatus EX thus constructed as mentioned above, accurate position information on the reticle R is measured using the reticle alignment system 14 shown in FIG. 1 and accurate position information on the wafer W is measured an alignment sensor, not shown, as a first step. Then, base on these measurement results and detection results from the laser interferometer 27 (laser interferometers 27X and 27Y), the relative position between the reticle R and the wafer W is adjusted. Then) the retile stage RST is driven to locate the reticle R to an exposure start position, and the wafer stage WST is driven to locate a shot area to be first exposed on the wafer W to an exposure start position.

Upon completion of the above processing, the movement of the reticle R and the wafer W is started, and a the moving speeds of the reticle stage RST and the wafer stage WST reach respectively predetermined speeds, slit-shaped illumination light is radiated onto the reticle R. After that, the reticle R and the wafer W are moved in synchronization with each other while monitoring the detection results from the laser interferometer 27 (laser interferometers 27X and 27Y) to transfer the pattern of the reticle R sequentially onto the wafer W. During pattern transfer, the attitude (rotation about the X axis and Y axis) of the wafer stage WST is controlled based on the measurement results from the AF sensor. Upon completion of the exposure processing for one shot area, the wafer stage WST is step-moved to locate a shot area to be next exposed to the exposure start position, and the exposure processing is performed in the same manner.

According to the exposure apparatus of the embodiment, since the wafer stage WST can be moved at high speed, high throughput can be achieved. When the wafer stage WST is accelerated to high velocity, temperature-uncontrolled air may be mixed in the light path of the laser light radiated from the laser interferometer 27 (laser interferometers 27X and 27Y) or the light path of the slit image radiated from the AF sensor. However, in the embodiment, since the air conditioning apparatuses 28X and 28Y are provided for supplying the down flow toward the light path radiated from the laser interferometer 27 and the air conditioning apparatus 29 is provided for supplying the lower side flow, the temperature-uncontrolled air getting mixed in the light path of the laser light can be prevented or reduced, thereby preventing the lowering of the detection accuracy of the laser interferometer 27. The air condition apparatus 34 is also provided for supplying temperature-controlled air over the wafer stage WST, and this can also prevent the lowering of the detection accuracy of the AF sensor.

In addition, when the wafer stage WST is accelerated to high velocity, since the amount of heat generated from the linear motors 38a and 38b, etc. increases, air warmed by this heat may get mixed in the light path of the laser light radiated from the laser interferometer 27, or the light path of the slit image projected from the AF sensor. However, in the embodiment, the shielding boxes 39a, 39b and the shielding sheets 42a, 42b are provided for enclosing the linear motors 38a and 38b, respectively, to shield between the space where the wafer stage WST is arranged and the space where each of the linear motors 38a and 38b is disposed, thereby preventing the lowering of the detection accuracy of the laser interferometer 27 and the AF sensor.

Thus, since the position of the reticle R, and the position and attitude of the wafer can be detected with a high degree of precision, exposure accuracy (pattern registration accuracy, etc.) can be improved. As a result, a device having a desired function can be manufactured efficiently with high yield.

The preferred embodiment of the present invention has been described, but the present invention is not limited to the aforementioned embodiment, and changes can be made freely within the scope of the present invention. For example, in the embodiment, in addition to the air conditioning apparatuses 28X and 28Y for supplying the down flow and the air conditioning apparatus 29 for supplying the lower side flow, the air conditioning apparatus 35 for supplying the temperature-controlled air over the wafer stage WST, the shielding boxes 39a and 39b for isolating the linear motors 38a and 38b, the temperature-controlled top board 49, and the shielding sheets 42a and 42b are all provided. However, all the elements are not necessarily required, and appropriate elements can be selected and used in combination with the air conditioning apparatuses 28X, 28Y, and 29. Of course, each of the elements can be used independently. Further, in the embodiment, the present invention is applied to the exposure apparatus provided with the X-axis laser interferometer 27X and the Y-axis laser interferometer 27Y as the laser interferometer for measuring positions in the two-dimensional plane of the wafer step WST, but the present invention is also applicable to an exposure apparatus provided with a Z-axis laser interferometer for measuring the position of the wafer stage WST in a direction (Z axis direction) perpendicular to a reference plane. Further, in the embodiment, the stage apparatus of the present invention is applied to the wafer stage WST of the exposure apparatus, but it is also applicable to the reticle stage RST provided in the exposure apparatus. Furthermore, the stage apparatus is applicable to stages other than that for the exposure apparatus, which are generally configured to be movable in at least either of the X direction and Y direction on such a condition that an object is loaded thereon.

Further, in the embodiment, the step-and-scan type exposure apparatus is taken as an example, but the present invention is also applicable to a step-and-repeat type exposure apparatus. Further, in addition to the exposure apparatus used in manufacturing semiconductor devices, the exposure apparatus of the present invention is applicable to an exposure apparatus used in manufacturing displays including liquid crystal display devices (LCDs), which transfers a device pattern onto a glass plate, an exposure apparatus used in manufacturing thin-film magnetic heads, which transfers a device pattern onto a ceramic wafer, an exposure apparatus used in manufacturing image pickup devices such as CCDs, etc.

Furthermore, the present invention is applicable to an exposure apparatus for transferring a circuit pattern to a glass substrate, a silicon wafer, or the like to manufacture a reticle or mask used in a photoexposure apparatus, an EUV exposure apparatus, an X-ray exposure apparatus, an electron-beam exposure apparatus, etc. Here, in case of an exposure apparatus using DUV (far ultraviolet) light or VUV (vacuum ultraviolet) light, a transmission type reticle is typically used, and quartz glass, quartz glass doped with fluorine, fluorite, magnesium fluoride, quartz crystal, or the like is used as the reticle substrate. Further, in case of an x-ray exposure apparatus or an electron-beam exposure apparatus based on a proximity system, a transmission mask (stencil mask or membrane mask) is used, and a silicon wafer or the like is used as the mask substrate. Such an exposure apparatus is disclosed in PCT International Publication Nos. WO 99/34255, WO 99/50712, and WO 99/66370, and Japanese Patent Application, Publication Nos. H11-194479, 2000-12453, and 2000-29202.

Furthermore, the present invention is applicable to an exposure apparatus using an immersion method as disclosed in PCT International Publication No. WO 99/49504+Here, the present invention is also applicable to an immersion exposure apparatus in which liquid is locally filled been the projection optical system PL and the wafer W, an immersion exposure apparatus as disclosed in Japanese Patent Application, Publication No. H06-124873, in which a stage holding a substrate to be exposed is moved in a liquid bath, or an immersion exposure apparatus as disclosed in Japanese Patent Application, Publication No. H10-303114 in which a liquid bath is formed to a predetermined depth on a stage so that a substrate will be held in the liquid bat.

In manufacturing a semiconductor device using the exposure apparatus of the embodiment, this semiconductor device is manufactured via the following steps, a step of designing the function/performance of the device, a step of making a reticle based on the design step; a step of forming a wafer W from a silicon material; a step of exposing the wafer W win a pattern on the reticle R using the exposure apparatus of the aforementioned embodiment; a device assembly step (including dicing, bonding, and packaging), an inspection step, etc.

1. A stage apparatus including a stage configured to be movable on a reference plane formed on a stage base, and an interferometer that irradiates the stage with a light beam parallel to the reference plane to measure the position of the stage, the apparatus comprising:
a first air-conditioning mechanism that supplies a gas adjusted to a predetermined temperature toward the light path of the light beam along a direction orthogonal to the reference plane; and
a second air-conditioning mechanism that supplies a gas adjusted to a predetermined temperature into a space between the light path of the light beam and the reference plane along the reference plane.

2. The stage apparatus according to claim 1, wherein the second air-conditioning mechanism supplies the gas with a width wider than the width of the stage in a direction orthogonal to the light path of the light beam.

3. The singe apparatus' according to claim 1 further comprising
a drive device arranged outside of a moving range of the stage on the reference plane to drive the stage based on the measurement results from the interferometer, and
a shield member that shields a space where the drive device is arranged from a space where at least the stage is arranged.

4. The stage apparatus according to claim 1, wherein the stage has a holding surface that holds a substrate, and the stage apparatus further comprises a third air-conditioning mechanism that supplies a gas adjusted to a predetermined temperature into a space over the holding surface.

5. The stage apparatus according to claim 4, wherein the wind velocity of the gas supplied from the first air-conditioning mechanism is equal to or higher than the wind velocity of the gas supplied from the third air-conditioning mechanism, and the wind velocity of the gas supplied from the third air-conditioning mechanism is equal to or higher than the wind velocity of the gas supplied from the second air-conditioning mechanism.

6. A stage apparatus including a stage configured to be movable within a moving range on a reference plane, an interferometer that irradiates the stage with a light beam parallel to the reference plane to measure the position of the stage, and a drive device arranged outside of the moving range to drive the stage based on the measurement results from the interferometer, the apparatus comprising:
a shield member that shields a space, where the drive device is arranged from a space where at least the stage is arranged.

7. The stage apparatus according to claim 6, wherein the shield member is a thin plate-like member having heat insulation properties and flexibility.

8. The stage apparatus according to claim 6, further comprising an exhaust mechanism that exhausts the gas from the space where the drive device shielded by the shield member is arranged.

9. The stage apparatus according to claim 8, further comprising an enclosing member that encloses the drive device,
wherein the exhaust mechanism exhausts a gas from a space inside the enclosing member where the drive unit is arranged.

10. A stage apparatus including a stage having a holding surface that holds a substrate and moving over a reference plane, the apparatus comprising:
a supply mechanism that supplies a gas adjusted to a predetermined temperate into a space over the holding surface; and
an air-intake mechanism provided to opposite the supply mechanism to suck in the gas over the holding surface.

11. The stage apparatus according to claim 10, wherein the air-intake mechanism is provided in the stage.

12. An exposure apparatus including a mask stage that holds a mask and a substrate stage that holds a substrate to transfer a pattern formed on the mask onto the substrate, the apparatus comprising the stage apparatus according to any one of claims 1 to 11 as at least either the mask stage or the substrate stage.

13. An exposure apparatus that radiates exposure light to form a pattern on a substrate, the apparatus comprising:
a stage movable over a reference plane formed on a stage base while holding the substrate;
a first interferometer that irradiates the stage with a light beam parallel to the reference plane along a first direction to measure the position of the stage in the first direction;
a second interferometer that irradiates the stage with a laser beam parallel to the reference plane along a second direction orthogonal to the first direction to measure the position of the stage in the second direction;
a first air-conditioning mechanism that supplies a gas adjusted to a predetermined temperature toward the light path of each light beam along a direction orthogonal to the reference plane; and
a second air-conditioning mechanism that supplies a gas adjusted to a predetermined temperate into a space between the light path of the light beam and the reference plane in a direction parallel to the first direction along the reference plane.

14. The exposure apparatus according to claim 13, wherein the second air-conditioning mechanism supplies the gas in a direction parallel to the first direction.

15. The exposure apparatus according to claim 14, wherein the exposure apparatus is a scanning type exposure apparatus that performs exposure during scanning the substrate, and
the first direction is a scanning direction.

16. The exposure apparatus according to claim 14, wherein the first air-conditioning mechanism supplies the gas at a flow rate higher a that of the second air-conditioning mechanism.
